(19) United States
(12) Patent Application Publication
(10) Pub. No.: US 2018/0293285 A1
(43) Pub. Date: Oct. 11, 2018

(54) INFORMATION PROVIDING METHOD, INFORMATION PROVIDING DEVICE, AND COMPUTER-READABLE RECORDING MEDIUM

(71) Applicant: FUJITSU LIMITED, Kawasaki-shi (JP)

(72) Inventors: Kei TAIRA, Kawasaki (JP); Motoshi SUMIOKA, Kawasaki (JP); Masahide NODA, Kawasaki (JP); Takashi OHNO, Kobe (JP); Tatsuro MATSUMOTO, Yokohama (JP)

(73) Assignee: FUJITSU LIMITED, Kawasaki-shi (JP)

(21) Appl. No.: 16/000,511

(22) Filed: Jun. 5, 2018

Related U.S. Application Data
(63) Continuation of application No. PCT/JP2015/084581, filed on Dec. 9, 2015.

(51) Int. Cl. G06F 17/30; G06Q 10/06

(52) U.S. Cl. CPC G06F 17/30554; G06Q 10/063114; G06Q 10/063112; G06F 17/30321; G06F 17/30595

(57) ABSTRACT

An information providing method includes: generating, at time of registering know-how with respect to a task defined in task information, a first-type status tag based on a user status including task information of a first task being executed by a first user; storing the first-type status tag in a corresponding manner to the know-how in a memory; generating a second-type status tag based on a user status including task information of a second task being executed by a second user; extracting, from a plurality of sets of know-how stored in the memory, know-how associated to the second-type status tag; and providing the extracted know-how to the second user.

### CROSS-REFERENCE TO RELATED APPLICATION

This application is a continuation application of International Application No. PCT/JP2015/084581, filed on Dec. 9, 2015 and designating the U.S., the entire contents of which are incorporated herein by reference.

### FIELD

The embodiment discussed herein is related to an information providing method, an information providing device, and a computer-readable recording medium.

### BACKGROUND

A technology is known in which templates are created for the workflows involved in the routinized work, and instances having parameters such as the executant, the location, and the period input therein are repeatedly executed. While a workflow is executed in a repeated manner, it is known that a user of the workflow refers to the comments made on an assignment-by-assignment basis by the past users, and is able to anticipate the work efficiency of the assignments. That is because the comments made by the past users include the know-how.

For example, as a technology for referring to the know-how, a technology has been disclosed in which a user provides search conditions to a searching unit; and a know-how information base searches for the know-how information and presents the search result to the user (for example, see Japanese Laid-open Patent Publication No. 09-251466).

However, in the related technology for referring to the know-how, it is difficult to provide appropriate know-how for the user. For example, in the technology for referring to the know-how, the know-how information base searches for the know-how information according to the search conditions provided by the user. Hence, unless the provided search conditions are appropriate, a large number of sets of know-how are retrieved and the desired know-how gets buried. As a result, the know-how information base cannot present the appropriate know-how for the user.

### SUMMARY

According to an aspect of the embodiments, an information providing method includes: generating, at time of registering know-how with respect to a task defined in task information, a first-type status tag based on a user status including task information of a first task being executed by a first user; storing the first-type status tag in a corresponding manner to the know-how in a memory; generating a second-type status tag based on a user status including task information of a second task being executed by a second user; extracting, from a plurality of sets of know-how stored in the memory, know-how associated to the second-type status tag; and providing the extracted know-how to the second user.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a configuration diagram of a system that includes a scheduling supporting device according to an embodiment;

FIG. 2 is a diagram illustrating an exemplary data structure of a know-how database (DB);

FIG. 3 is a diagram illustrating an exemplary data structure of a task DB;

FIG. 4 is a diagram illustrating an example of a status tag generation operation according to the embodiment;

FIG. 5 is a diagram illustrating an example of a know-how extraction operation according to the embodiment;

FIG. 6 is a flowchart for explaining a status tag generation operation according to the embodiment;

FIG. 7 is a flowchart for explaining a know-how registration operation according to the embodiment;

FIG. 8 is a flowchart for explaining a know-how presentation operation according to the embodiment;

FIG. 9 is a diagram illustrating a specific example of the know-how registration operation according to the embodiment;

FIG. 10 is a diagram illustrating a specific example of the know-how presentation operation according to the embodiment;

FIG. 11 is a diagram illustrating a different example of the status tag generation operation according to the embodiment;

FIG. 12 is a diagram illustrating an example of prompting for know-how registration; and

FIG. 13 is a diagram illustrating an exemplary computer that executes an information providing program.

### DESCRIPTION OF EMBODIMENT(S)

Preferred embodiments will be explained with reference to accompanying drawings. However, the invention is not limited by the embodiment.

Given below is the explanation of the meaning of the terms used in the written description. Herein, the term “task” is used as a term that can cover the overall actions performed by a person. An example of a “task” is the jobs performed in an assignment. However, that is not the only possible case. That is, a “task” can also cover actions such as traveling or dining in one's private time. Moreover, a “task” can also cover taking rest in between a plurality of actions, and moving to a particular place for performing the next action. Meanwhile, “task information” represents the information defining the task details. For example, the “task information” can contain the specific job details, the task executants, the number of task executants, the time taken for task execution, the restrictions on task execution, the location of task execution, and the tools used in task execution. Herein, the “task information” may contain information defining the estimated start timing and the estimated end timing of a task and may contain information not defining the estimated start timing and the estimated end timing of a task. The details of the “task information” are given later. Meanwhile, “scheduling” either implies setting, for a task for which the estimated start timing and the estimated end timing are not set, at least either the estimated start timing or the estimated end timing; or implies resetting, for a task for which at least either the estimated start timing or the estimated end timing are set, a new estimated start timing or a new estimated end timing. Moreover, a “schedule” represents information indicating the result of performing the “scheduling”. When the “schedule” is displayed in a form that is recognizable to a person using the eyesight, or using the auditory sensor, or using the olfactory sense; it is called a “timetable”. Furthermore, “mediation” implies identifying the order of execution of a plurality of tasks and scheduling the tasks.

### Embodiment

Configuration of Scheduling Supporting System

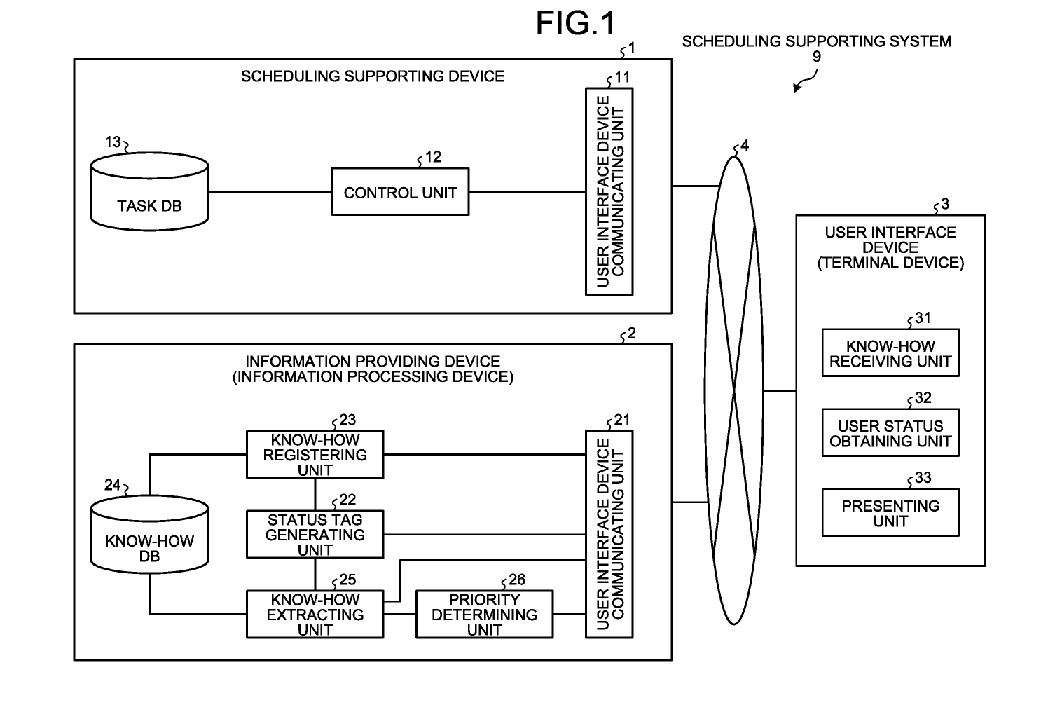

FIG. 1 is a configuration diagram of a system that includes a scheduling supporting device according to the embodiment. A scheduling supporting system 9 includes a scheduling supporting device 1, an information providing device 2, and a user interface device 3. The information providing device 2 is connected to the scheduling supporting device 1 and the user interface device 3 via a network 4. As an example, the information providing device 2 is equivalent to an information processing device.

The scheduling supporting device 1 performs scheduling related to a plurality of tasks based on the order of execution of the tasks (a task flow) defined in each of a plurality of sets of task information. Then, the scheduling supporting device 1 sends a schedule, which is obtained as a result of scheduling, to the user interface device 3. Meanwhile, in the embodiment, the task flow is assumed to have the same meaning as the work flow.

The user interface device 3 is an electronic device that can be used by the executant of a task. The user interface device 3 can make the executant of a task aware of the task details and the scheduling details. Moreover, using the user interface device 3, the executant of a task can issue a know-how registration request and a know-how presentation request to the information providing device 2. Herein, the user interface device 3 is equivalent to a handheld terminal device represented by a smartphone. However, that is not the only possible case. Alternatively, the user interface device 3 can be a laptop personal computer, a desktop personal computer, or a personal digital assistant (PDA). In the following explanation, the user interface device 3 is sometimes referred to as a terminal device.

At the time of registering the know-how with respect to a task defined in the task information, the information providing device 2 generates a status tag based on the user status that includes the task information of the task being executed by the executant who requested for the registration of the know-how. The information providing device 2 stores the generated status tag in a corresponding manner to the concerned know-how in a memory unit. At the time of presenting the know-how, the information providing device 2 generates a status tag based on the user status that includes the task information of the task being executed by the executant who requested for the presentation of the know-how. From a plurality of sets of know-how stored in the memory unit, the information providing device 2 extracts the know-how associated to the generated status tag, and provides the extracted know-how to the executant who issued the request. That is, at the time of registration of the know-how and at the time of presentation of the know-how, the information providing device 2 automatically generates the status tag from the user status in the same manner and makes use of the generated status tag. Hence, the information providing device 2 can extract and present the know-how that is appropriate for the user status of the executant of the task.

Configuration of Scheduling Supporting Device

Firstly, the explanation is given about a configuration of the scheduling supporting device 1. The scheduling supporting device 1 includes a user interface device communicating unit 11, a control unit 12, and a task database (DB) 13.

The user interface device communicating unit 11 performs communication with the user interface device 3. For example, the user interface device communicating unit 11 sends, to the terminal device 3, a schedule related to a plurality of tasks as generated by the control unit 12 (described below).

The control unit 12 refers to the task flow of the tasks as defined in each of a plurality of sets of task information and refers to the task information of each task, and mediates the scheduled execution periods of a plurality of tasks. As a result, the control unit 12 generates a schedule related to a plurality of tasks. Then, the control unit 12 communicates with the terminal device 3 via the user interface device communicating unit 11, and finalizes the schedule according to the communication. The schedule includes the task information.

The task DB 13 is used to store the task information. The task information stored in the task DB 13 can be information set from a task information source (not illustrated), or can be information input from an input device installed in the scheduling supporting device 1, or can be information sent from the terminal device 3. The case in which the task information is sent from the terminal device 3 implies that, for example, the executant of a task himself or herself creates task information and writes it in the terminal device 3, and requests the scheduling supporting device 1 for mediation. Meanwhile, the data structure of the task DB 13 is explained later.

Configuration of Information Providing Device

Given below is the explanation of a configuration of the information providing device 2. The information providing device 2 includes a user interface device communicating unit 21, a status tag generating unit 22, a know-how registering unit 23, a know-how DB 24, a know-how extracting unit 25, and a priority determining unit 26.

The user interface device communicating unit 21 performs communication with terminal device 3. For example, the user interface device communicating unit 21 sends a know-how registration request, which is issued from the terminal device 3, to the status tag generating unit 22. Moreover, the user interface device communicating unit 21 sends know-how, which is sent from the terminal device 3, to the know-how registering unit 23. Furthermore, the user interface device communicating unit 21 sends a know-how presentation request, which is issued from the terminal device 3, to the status tag generating unit 22. Moreover, the user interface device communicating unit 21 sends, to the terminal device 3, such know-how whose priority has been determined by the priority determining unit 26 (described later).

When a know-how registration request is received, the status tag generating unit 22 generates a status tag based on the user status that includes the task information of the task being executed by the user who issued the know-how registration request.

Herein, the “user status” implies various parameters included in the task information of the task being executed by the user and implies various parameters that are directly input by the user. In addition, the user status implies execution information of the application used in the execution of the task and implies sensing information about the location of execution of the task by the user. That is, the user status represents the status related to the user during the execution of the task by that user. Moreover, the “status tag” represents a tag obtained from the user status, and implies a tag that is linkable to the know-how to be sent to the know-how registering unit 23 (described later).

Meanwhile, when a know-how presentation request is received, the status tag generating unit 22 generates a status tag based on the user status that includes the task information of the task being executed by the user who issued the know-how presentation request. The status tag is generated by implementing the same method as the method implemented in response to the receipt of a know-how registration request. As a result, the status tag generating unit 22 can generate a unique status tag at the time of know-how registration and a unique status tag at the time of know-how presentation.

When a know-how registration request is received, the know-how registering unit 23 registers the concerned know-how in a corresponding manner to the status tag. For example, the know-how registering unit 23 obtains the status tags generated by the status tag generating unit 22. Then, the know-how registering unit 23 selects a status tag corresponding to the concerned know-how from among the obtained status tags. Subsequently, the know-how registering unit 23 stores the selected status tag in a corresponding manner to the concerned know-how in the know-how DB 24. Examples of the method for selection of the status tag include a method in which the user is made to select the status tag, and a method in which the tags included in the status tag are collated with the words obtained as a result of morphological analysis of the concerned know-how and a matching word is set as the status tag.

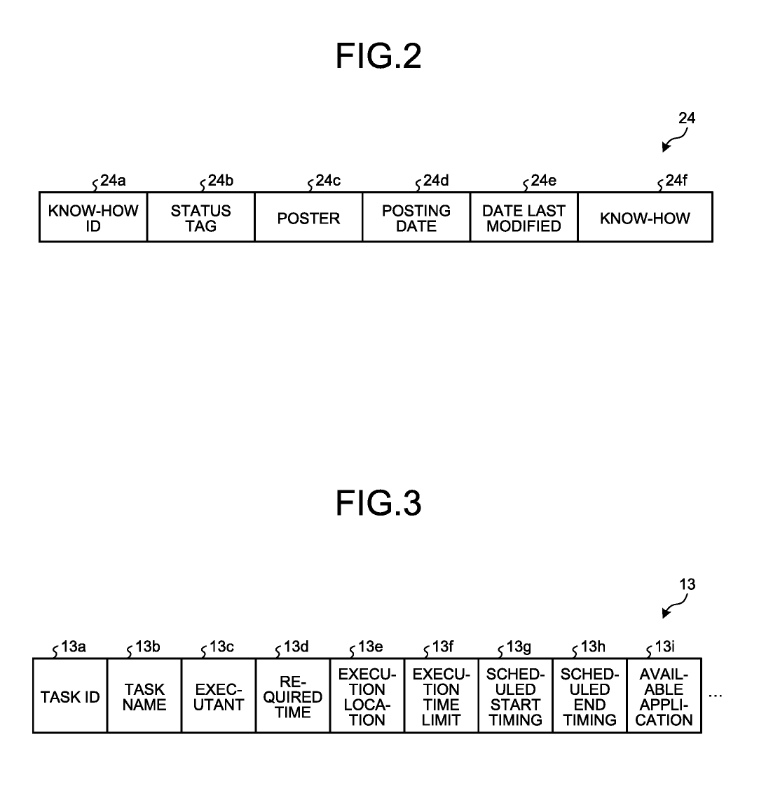

The know-how DB 24 is used to store the know-how registered by the know-how registering unit 23. The data structure of the know-how DB 24 is explained below with reference to FIG. 2.

FIG. 2 is a diagram illustrating an exemplary data structure of the know-how DB. As illustrated in FIG. 2, in the know-how DB 24, a status tag 24b, a poster tag 24c, a posting date 24d, a date last modified 24e, and know-how 24f are stored in a corresponding manner to a know-how identifier (ID) 24a. The know-how ID 24a is an identifier that is uniquely assigned to each set of know-how. The status tag 24b represents the status tag associated to the know-how. The poster tag 24c represents the name of the user who requested know-how registration. The posting date 24d represents the date and time of registration of the know-how by the user. The date last modified 24e represents the date and time at which the record associated to the know-how ID 24a was last modified. The know-how 24f represents the know-how that gets registered by the know-how registering unit 23.

Returning to the explanation with reference to FIG. 1, when a know-how presentation request is received, the know-how extracting unit 25 extracts the know-how associated to the concerned status tag. For example, the know-how extracting unit 25 obtains, as the status tag for use, the status tag generated by the status tag generating unit 22. Then, with the status tag for use serving as the key, the know-how extracting unit 25 extracts the concerned know-how from the know-how DB 24. As an example, the know-how extracting unit 25 extracts the know-how exactly matching with the status tag for use, extracts the know-how partially matching with the status tag for use, and extracts the know-how having identical tags. The partial matching includes two types of partial matching, namely, a first-type partial matching in which the set of status tags for use includes the set of status tags associated to know-how, and a second-type partial matching in which the set of status tags associated to know-how includes the set of status tags for use.

The priority determining unit 26 determines the priority of the sets of know-how, which are extracted by the know-how extracting unit 25, according to the degree of coincidence of the status tags. The priority indicates the order in which the sets of know-how are presented to the user. For example, the priority determining unit 26 assigns the priority to the sets of know-how in the order of exact matching, first-type partial matching, second-type partial matching, and existence of matching.

Moreover, as a response to the know-how presentation request, the priority determining unit 26 sends, to the terminal device 3 that had issued the request, the know-how extracted by the know-how extracting unit 25. For example, the priority determining unit 26 sends, in the order of priority, the sets of know-how including the status tags. Herein, it is explained that the priority determining unit 26 sends the sets of know-how according to the order of priority. However, alternatively, only a predetermined top N number of sets of know-how can be sent, or only the topmost set of know-how can be set.

Configuration of User Interface Device (Terminal Device)

Given below is the explanation of a configuration of the terminal device 3. The terminal device 3 includes a know-how receiving unit 31, a user status obtaining unit 32, and a presenting unit 33.

When a task is being executed by the user, the know-how receiving unit 31 receives the know-how related to that task. Then, the know-how receiving unit 31 sends the received know-how along with a know-how registration request to the information providing device 2.

The user status obtaining unit 32 obtains the user status. For example, the user status obtaining unit 32 obtains, as the user status, various parameters included in the task information of the task being executed by the user. Moreover, the user status obtaining unit 32 obtains, as the user status, execution information of the application used in executing the task. Furthermore, the user status obtaining unit 32 obtains, as the user status, sensing information about the location of execution of the task. The sensing information can be information obtained from an environment sensor installed in a fixed manner, or can be information obtained from an environment sensor such as a wearable device that is portable.

Moreover, the user status obtaining unit 32 sends the obtained user status to the information providing device 2.

When a task is being executed by the user, the presenting unit 33 sends a presentation request to the information providing device 2 for presenting the sets of know-how related to that task. Moreover, when the sets of know-how are received in response to the know-how presentation request, the presenting unit 33 presents the received sets of know-how. That is, regarding the sets of know-how sent in the order of priority, the presenting unit 33 presents the sets of know-how in the order of priority.

Exemplary Data Structure of Task DB

Explained below with reference to FIG. 3 is an exemplary data structure of the task DB 13. FIG. 3 is a diagram illustrating an exemplary data structure of the task DB. As illustrated in FIG. 3, the task DB 13 is used to store the following items in a corresponding manner to task ID 13a: task name 13b, executant 13c, required time 13d, execution location 13e, execution time limit 13f, scheduled start timing 13g, scheduled end timing 13h, and available application 13i. The task ID 13a represents information of the item that is uniquely assigned to each task. The task name 13b represents information of the item meant for succinctly expressing the task details to enable easy understanding of the task details for the executant of the task. The executant 13c represents information of the item meant for identifying the user who executes the task. The required time 13d indicates the period of time that is roughly requested to execute the task. For example, the required time 13d can be set using the average period of time that was taken for executing the concerned task in the past. The execution location 13e indicates the location of execution of the task. The execution time limit 13f indicates the time limit for executing the task. The scheduled start timing 13g represents the scheduled timing for starting the execution of the task. The scheduled end timing 13h represents the scheduled timing for ending the execution of the task. The available application 13i indicates the application or the software to be used in executing the task. Meanwhile, the data structure of the task DB 13 is not limited to this example, and can include other information as well.

Example of Status Tag Generation Operation

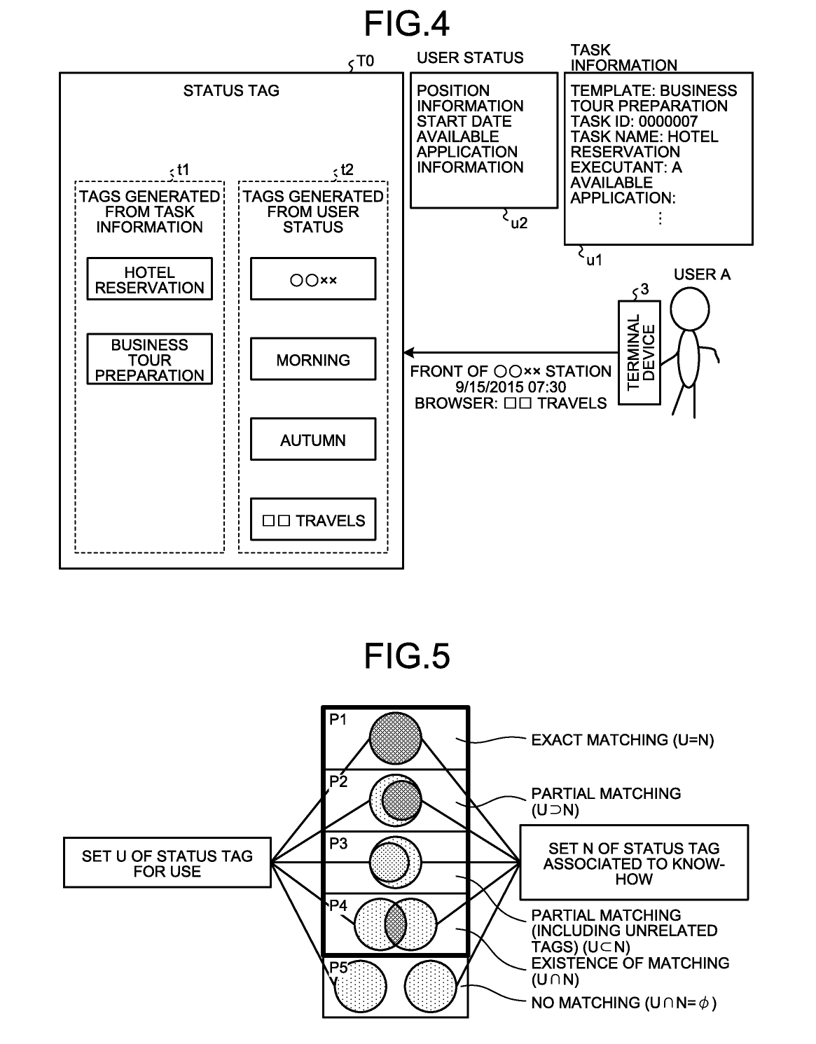

Explained below with reference to FIG. 4 is an example of a status tag generation operation according to the embodiment. FIG. 4 is a diagram illustrating an example of the status tag generation operation according to the embodiment. As illustrated in FIG. 4, when a user A of the terminal device 3 is executing a task of hotel reservation, he or she registers the know-how of that task. Moreover, it is assumed that task information u1 of the task being executed has “hotel reservation” as the task name, has “A” as the executant, and has “” as an indication that no setting is done regarding the available application. Furthermore, it is assumed that a user status u2 has “front of ∘∘×× station” as location information, has “9/15/2015 07:30” as the start date, and has “browser: □□□ travels” as available application information. As an example, the location information is obtained from a GPS sensor installed in the terminal device 3. As an example, the start time is obtained from a time sensor installed in the terminal device 3. The available application information represents execution information of the application that is actually executing the task, and is obtained from the terminal device 3.

Under such a status, when a know-how registration request is received from the terminal device 3, the status tag generating unit 22 generates a status tag T0 based on the task information u1 of the task being executed by the user A, who requested for know-how registration, and based on the user status u2. Herein, the status tag generating unit 22 generates, as the status tag T0, a task name and a template from the task information u1. That is, a task name “hotel reservation” and a template “business tour preparation” are generated as a status tag T0(t1). In addition, the status tag generating unit 22 obtains the location information, the start time, and the available application information from the user status u2. That is, “∘∘××” is obtained as the location information, “9/15/2015 07:30” is obtained as the start date, and “browser: □□□ travels” is obtained as the available application information. Then, the status tag generating unit 22 generates “∘∘××” from “∘∘××”, generates “morning” and “autumn” from “9/15/2015 07:30”, and generates “□□□ travels” from “browser: □□□ travels” as a status tag T0(t2).

As an example, the know-how registering unit 23 makes the user select the generated status tag T0, and stores the selected status tag T0 in a corresponding manner to the concerned know-how in the know-how DB 24.

Subsequently, when a know-how presentation request is received from the terminal device 3, the status tag generating unit 22 generates a status tag based on the user status that includes the task information of the task being executed by a user B (not illustrated) who requested for know-how presentation. Herein, the status tag is generated by implementing the same method as the method implemented in the case of receiving a task registration request. As a result, the status tag generating unit 22 can generate a unique status tag at the time of know-how registration and a unique status tag at the time of know-how presentation, and can present the appropriate know-how for the user B using the status tag.

Example of Know-How Extraction Operation

Explained below with reference to FIG. 5 is an example of a know-how extraction operation according to the embodiment. FIG. 5 is a diagram illustrating an example of the know-how extraction operation according to the embodiment. With reference to FIG. 5, the status tags at the time of using the sets of know-how are referred to as a set U. That is, the status tags at the time of using the sets of know-how represent the status tags when a know-how presentation request is received by the know-how extracting unit 25. Meanwhile, the status tags that are stored in the know-how DB 24 and that are associated to the sets of know-how are referred to as a set N.

As illustrated in FIG. 5, regarding the set U of the status tag at the time of using the know-how, five patterns of set relationship, namely, patterns P1 to P5 can be listed in relationship to the set N of the status tag associated to the know-how. The pattern P1 represents the case of exact matching of the set U and the set N. The pattern P2 represents the case of partial matching of the set U and the set N. That is, the pattern P2 represents the case of first-type partial matching in which the set U includes the set N. The pattern P3 represents the case of partial matching of the set U, the set N, and unrelated tags. That is, the pattern P3 represents the case of second-type partial matching in which the set N includes the set U. The pattern P4 represents the case of existence of matching tags. The pattern P5 represents the case of no matching tags, that is, represents the case of an empty set.

The know-how extracting unit 25 obtains the status tags, which are generated by the status tag generating unit 22, as the status tags for use; and, with the obtained status tags for use serving as the keys, extracts the concerned know-how from the know-how DB 24. Herein, regarding the set U of the status tag for use, in relationship to the set N of the status tag associated to the know-how, the know-how extracting unit 25 extracts the know-how having the set relationship of the patterns P1 to P4 from the know-how DB 24.

Regarding the sets of know-how extracted by the know-how extracting unit 25, the priority determining unit 26 assigns priority, in the order of the patterns P1 to P4, to the sets of know-how associated to the status tags for use. Meanwhile, when sets of know-how having the same priority are present, the priority determining unit 26 can give priority to the know-how having the latest posting date 24d.

Flowchart of Status Tag Generation Operation

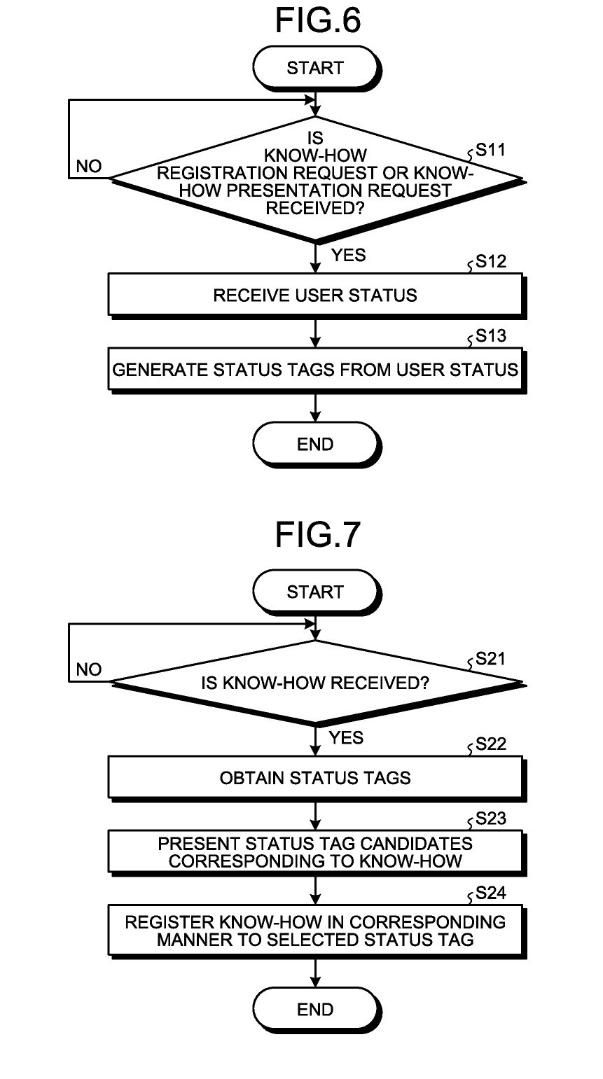

Explained below with reference to FIG. 6 is a sequence of operations performed in the status tag generation operation according to the embodiment. FIG. 6 is a flowchart for explaining the status tag generation operation according to the embodiment.

As illustrated in FIG. 6, the status tag generating unit 22 determines whether or not a know-how registration request or a know-how presentation request is received from the terminal device 3 (Step S11). If it is determined that a know-how registration request or a know-how presentation request is not received (No at Step S11), then the status tag generating unit 22 repeats the determination operation until a know-how registration request or a know-how presentation request is received.

If it is determined that a know-how registration request or a know-how presentation request is received (Yes at Step S11), then the status tag generating unit 22 receives the user status from the terminal device 3 (Step S12). Subsequently, the status tag generating unit 22 generates the status tags from the received user status (Step S13) and ends the status tag generation operation. The method for generating the status tags is same regardless of whether a know-how registration request is received or a know-how presentation request is received. As a result, the status tag generating unit 22 can generate a unique status tag at the time of know-how registration and a unique status tag at the time of know-how presentation.

Flowchart for Know-How Registration Operation

Explained below with reference to FIG. 7 is a sequence of operations performed in a know-how registration operation according to the embodiment. FIG. 7 is a flowchart for explaining the know-how registration operation according to the embodiment.

As illustrated in FIG. 7, the know-how registering unit 23 determines whether or not know-how is received from the terminal device 3 (Step S21). If it is determined that know-how is not received (No at Step S21), then the know-how registering unit 23 repeats the determination operation until know-how is received.

When it is determined that know-how is received (Yes at Step S21), the know-how registering unit 23 obtains the status tags from the status tag generating unit 22 (Step S22). Then, the know-how registering unit 23 presents the obtained status tags as status tag candidates corresponding to the received know-how to the terminal device 3 (Step S23). That is done to enable the user to select the status tag corresponding to the know-how.

Subsequently, when the selected status tag is received from the terminal device 3, the know-how registering unit 23 registers the selected status tag in a corresponding manner to the know-how in the know-how DB 24 (Step S24). Then, the know-how registering unit 23 ends the know-how registration operation.

Flowchart of Know-How Presentation Operation

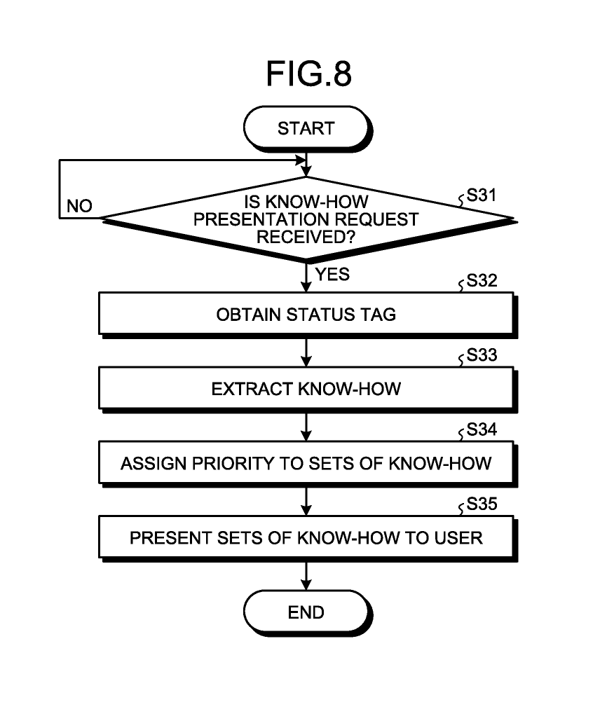

Explained below with reference to FIG. 8 is a sequence of operations performed in a know-how presentation operation according to the embodiment. FIG. 8 is a flowchart for explaining the know-how presentation operation according to the embodiment.

As illustrated in FIG. 8, the know-how extracting unit 25 determines whether or not a know-how presentation request is issued (Step S31). If it is determined that a know-how presentation request is not issued (No at Step S31), then the know-how extracting unit 25 repeats the determination operation until a know-how presentation request is issued.

When it is determined that a know-how presentation request is issued (Yes at Step S31), the know-how extracting unit 25 obtains the status tag from the status tag generating unit 22 (Step S32). Then, with the obtained status tag serving as the key, the know-how extracting unit 25 extracts the concerned know-how from the know-how DB 24 (Step S33). For example, regarding the set U of the obtained status tag, in relationship to the set N of the status tag associated to the know-how, the know-how extracting unit 25 extracts the know-how of the set relationship of the patterns P1 to P4 from the know-how DB 24. The pattern P1 represents the case of exact matching of the set U and the set N. The pattern P2 represents the case of partial matching of the set U and the set N. That is, the pattern P2 represents the case of first-type partial matching in which the set U includes the set N. The pattern P3 represents the case of partial matching of the set U, the set N, and unrelated tags. That is, the pattern P3 represents the case of second-type partial matching in which the set N includes the set U. The pattern P4 represents the case of existence of matching tags.

Subsequently, the priority determining unit 26 assigns priority to the extracted sets of know-how (Step S34). For example, regarding the sets of know-how extracted by the know-how extracting unit 25, the priority determining unit 26 assigns, in the order of the patterns P1 to P4, priority to the sets of know-how associated to the status tags at the time of know-how presentation. Meanwhile, when sets of know-how having the same priority are present, the priority determining unit 26 can give priority to the know-how having the latest posting date 24d.

Then, the priority determining unit 26 sends the sets of know-how, which are extracted by the know-how extracting unit 25, to the terminal device 3 as a response to the know-how presentation request, so that the sets of know-how are presented to the user (Step S35). The priority determining unit 26 sends the sets of know-how in the order of priority. As a result, the priority determining unit 26 can present the sets of know-how to the user, who had issued the know-how presentation request, in the order estimated to be appropriate for the task that is being actually executed by the user.

Specific example of know-how registration operation and know-how presentation operation

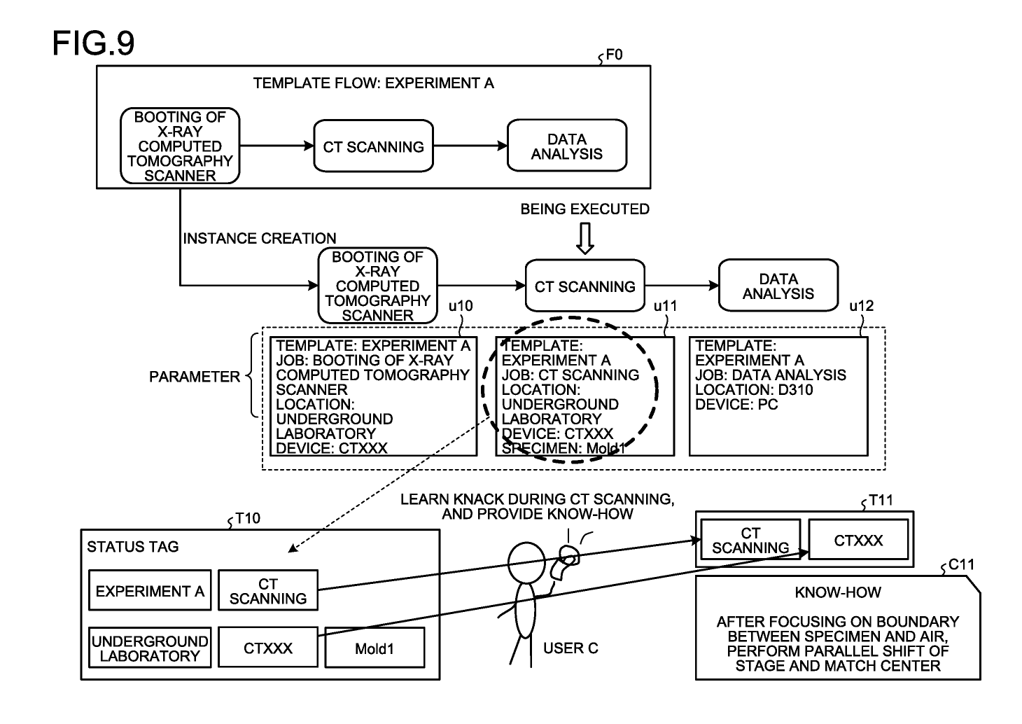

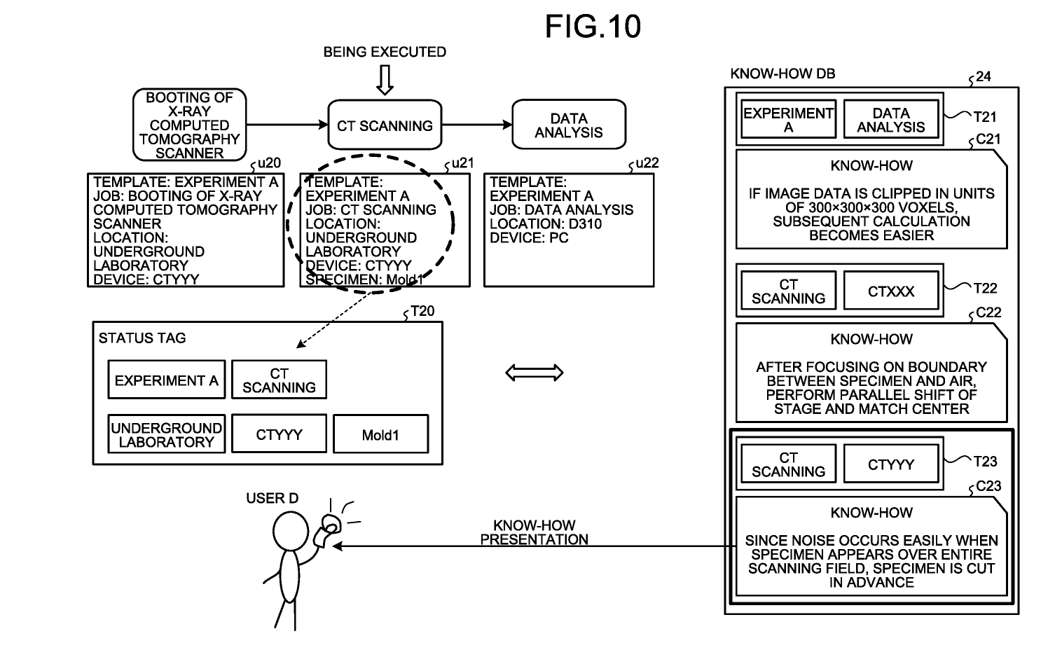

Explained below with reference to FIGS. 9 and 10 is a specific example of the know-how registration operation and a specific example of the know-how presentation operation according to the embodiment. FIG. 9 is a diagram illustrating a specific example of the know-how registration operation according to the embodiment. FIG. 10 is a diagram illustrating a specific example of the know-how presentation operation according to the embodiment.

As illustrated in FIG. 9, in a template flow F0 regarding an experiment A; “booting of X-ray computed tomography scanner”, “CT scanning”, and “data analysis” are set as tasks in that order. The scheduling supporting device 1 creates an instance by inputting various parameters with respect to each task of the template flow F0 with the aim of performing scheduling for a user C; and makes each task executable. For example, task information u11 during the execution of the task of “CT scanning” indicates “experiment A” as the template; indicates “CT scanning” as the job (task name); indicates “underground laboratory” as the location; indicates “CTXXX” as the device; and indicates “Mold1” as the specimen. Herein, the various parameters of the task information u11 are assumed to represent the user status.

Under such a status, assume that the user C is actually executing the task of “CT scanning”. The user C learns the knack for CT scanning, and posts the know-how. Then, in the terminal device 3, the know-how receiving unit 31 receives the know-how from the user C, and sends the received know-how along with a know-how registration request to the information providing device 2.

In the information providing device 2, the know-how registering unit 23 receives the know-how registration request from the terminal device 3 of the user C, and receives know-how C11 from the terminal device 3.

Moreover, when the know-how registration request is received from the terminal device 3 of the user C, the status tag generating unit 22 generates a status tag T10 based on the user status including the task information u11 of the task of “CT scanning” being executed by the user C. Herein, the status tag generating unit 22 generates, from the task information u11, the status tag T10 including the template, the job (task name), the location, the device, and the specimen. That is, “experiment A”, “CT scanning”, “underground laboratory”, “CTXXX”, and “Mold1” are generated as the status tag T10.

Then, the know-how registering unit 23 sends the generated status tag T10 to the terminal device 3. That is done to make the user C select the status tag corresponding to the know-how. Moreover, the know-how registering unit 23 stores a status tag T11, which is selected by the user C, in a corresponding manner to the know-how C11 in the know-how DB 24.

As illustrated in FIG. 10, assume that a separate instance is created regarding the experiment A. That is, the scheduling supporting device 1 creates an instance by inputting various parameters with respect to each task of the template flow F0 with the aim of performing scheduling for a user D; and makes each task executable. For example, task information u21 during the execution of the task of “CT scanning” indicates “experiment A” as the template; indicates “CT scanning” as the job (task name); indicates “underground laboratory” as the location; indicates “CTYYY” as the device; and indicates “Mold1” as the specimen. Herein, the various parameters of the task information u21 are assumed to represent the user status.

Under such a status, assume that the user D is actually executing the task of “CT scanning”. The user D requests for the presentation of the know-how of CT scanning. In response, the presenting unit 33 of the terminal device 3 issues a know-how presentation request to the information providing device 2.

In the information providing device 2, upon receiving the know-how presentation request from the terminal device 3 of the user D, the status tag generating unit 22 generates a status tag T20 based on the user status including the task information u21 of the task of “CT scanning” being executed by the user D. Herein, the status tag generating unit 22 generates, as the status tag T20, the template, the job (task name), the location, the device, and the specimen from the task information u21. That is, “experiment A”, “CT scanning”, “underground laboratory”, “CTYYY”, and “Mold1” are generated as the status tag T20.

The know-how extracting unit 25 obtains the status tag T20, which is generated by the status tag generating unit 22, as the status tag for use; and, with the status tag T20 for use serving as the key, extracts the concerned know-how from the know-how DB 24. Herein, regarding the set U of the status tag for use, in relationship to the set N of the status tag associated to the know-how in the know-how DB 24, the know-how extracting unit 25 extracts the know-how having the set relationship of the patterns P1 to P4 from the know-how DB 24. The pattern P1 represents the case of exact matching of the set U and the set N. The pattern P2 represents the case of partial matching of the set U and the set N. The pattern P3 represents the case of partial matching of the set U, the set N, and unrelated tags. The pattern P4 represents the case of existence of matching tags.

That is, regarding the set U of the status tag T20, in relationship to the set N of the status tag T21 associated to know-how C21 in the know-how DB 24, “experiment A” is matching but “data analysis” is not matching, thereby representing the pattern P4. Hence, the know-how extracting unit 25 extracts the know-how C21 corresponding to the status tag T21 from the know-how DB 24. Moreover, regarding the set U of the status tag T20, in relationship to the set N of a status tag T22 associated to know-how C22 in the know-how DB 24, “CT scanning” is matching but “CTXXX” is not matching, thereby representing the pattern P4. Hence, the know-how extracting unit 25 extracts the know-how C22 corresponding to the status tag T22 from the know-how DB 24. Furthermore, regarding the set U of the status tag T20, in relationship to the set N of a status tag T23 associated to know-how C23 in the know-how DB 24, there is partial matching in which “CT scanning” and “CTYYY” are matching, thereby representing the pattern P2. Hence, the know-how extracting unit 25 extracts the know-how C23 corresponding to the status tag T23 from the know-how DB 24.

Then, the priority determining unit 26 assigns priority to the sets of know-how C21, C22, and C23, which are extracted by the know-how extracting unit 25 and which are associated to the status tag T20, in the order of the patterns P1 to P4. Herein, the priority determining unit 26 assigns priority in the order of the know-how C23, the know-how C21, and the know-how C22. Since the know-how C21 and the know-how C22 represent the pattern P4, the priority determining unit 26 can give priority to the know-how having the latest posting date 24d.

Then, the priority determining unit 26 sends the know-how C23 having the highest priority to the terminal device 3 of the user D. Subsequently, the presenting unit 33 of the terminal device 3 presents the know-how C23. Herein, although it is explained that the priority determining unit 26 sends the know-how C23 having the highest priority, that is not the only possible case. Alternatively, the priority determining unit 26 can send the sets of know-how C23, C21, and C22 in the order of priority. In that case, the presenting unit 33 of the terminal device 3 presents the sets of know-how C23, C21, and C22 in the order of priority.

Herein, it is explained that the status tag generating unit 22 generates a status tag based on the user status including the task information of the task being executed by the user who requested for know-how registration. However, that is not the only possible case. Alternatively, the status tag generating unit 22 can generate a status tag based on the user status that includes the task information of the task being executed and includes information decided in the preceding tasks.

Different Example of Status Tag Generation Operation

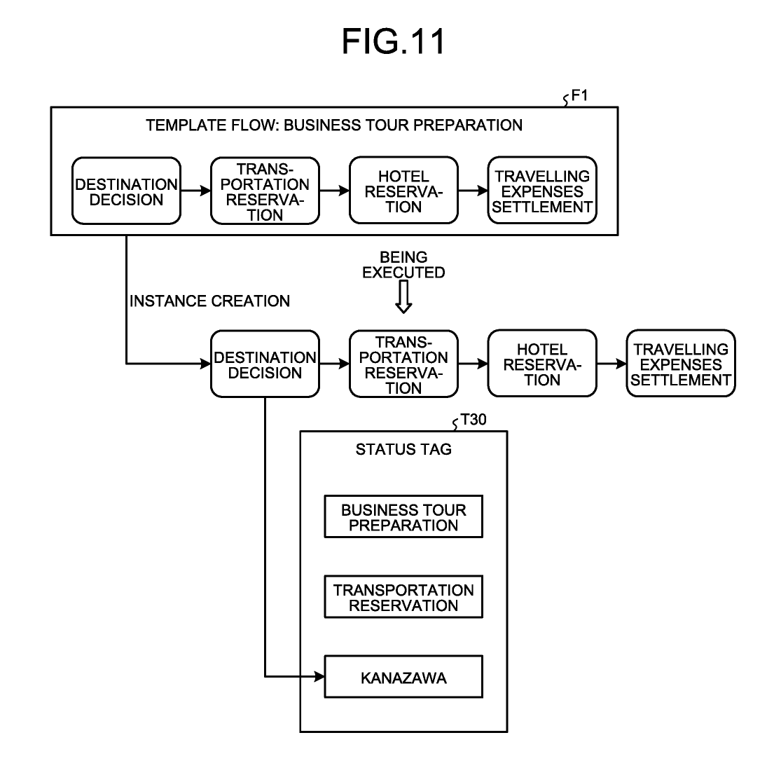

The following explanation is given about the case in which the status tag generating unit 22 generates a status tag based on the user status that includes the task information of the task being executed and includes information decided in the preceding tasks. FIG. 11 is a diagram illustrating a different example of the status tag generation operation according to the embodiment. As illustrated in FIG. 11, in a template flow F1 regarding business tour preparation; “destination decision”, “transportation reservation”, “hotel reservation”, and “traveling expenses settlement” are set as tasks in that order. The scheduling supporting device 1 creates an instance by inputting various parameters with respect to each task of the template flow F1 with the aim of performing scheduling for the user; and makes each task executable. At the point of time of creation of the instance, the task information of “transportation reservation” is assumed to have “business tour preparation” set as the template and have “transportation reservation” set as the task name.

Under such a status, assume that, the user is executing the task of “transportation reservation” after having executed the task of “destination decision”. The status tag generating unit 22 generates a status tag T30 based on the user status including the task information of the task of “transportation reservation” being executed by the user. In addition, the status tag generating unit 22 adds, to the status tag T30, the tags decided in the task of “destination decision” executed previously. That is, at the point of time of completion of execution of the preceding task, the status tag generating unit 22 generates the status tag T30 using the tags newly decided in the preceding task. As a result, the status tag generating unit 22 can generate the status tag T30 having a high degree of accuracy. Hence, using the status tag T30 having a high degree of accuracy, the status tag generating unit 22 can provide the know-how that is still more appropriate to the user.

### Effect of Embodiment

In this way, according to the embodiment described above, in the information providing device 2, at the time of registering the sets of know-how with respect to the tasks defined in task information, first-type status tags are generated based on the user status including the task information of the first task being executed by the first user. Then, in the information providing device 2, the first-type status tags are stored in a corresponding manner to the sets of know-how in the know-how DB 24. Subsequently, in the information providing device 2, second-type tags are generated based on the user status including the task information of the second task being executed by the second user. Then, in the information providing device 2, from a plurality of sets of know-how stored in the know-how DB 24, the sets of know-how associated to the second-type status tags are extracted. Subsequently, the information providing device 2 provides the extracted sets of know-how to the second-type user. With such a configuration, the information providing device 2 can provide the appropriate know-how for the user status to the second user.

Moreover, in the embodiment described above, in the information providing device 2, first-type status tags are generated based on the task information of the first task being executed by the first user and based on the information decided in the preceding task. Moreover, in the information providing device 2, second-type status tags are generated based on the task information of the second task being executed by the second user and based on the information decided in the preceding task. With such a configuration, status tags having a high degree of accuracy can be generated in the information providing device 2. As a result, using the status tags having a high degree of accuracy, the information providing device 2 can also provide the appropriate know-how for the second user.

Furthermore, in the embodiment described above, in the information providing device 2, when a plurality of sets of know-how is extracted, the ordering of the extracted sets of know-how at the time of providing them is performed according to the degrees of coincidence between the status tags associated to the extracted sets of know-how and the second-type status tags. The information providing device 2 provides the extracted sets of know-how according to the ordering to the second user. With such a configuration, even if a plurality of sets of know-how is extracted, the information providing device 2 can provide the sets of know-how in an efficient manner.

Miscellaneous

Meanwhile, in the embodiment described above, it is explained that, when a know-how registration request is received, the know-how registering unit 23 registers the know-how in a corresponding manner to the status tag in the know-how DB 24. However, that is applicable not only in the case of receiving a know-how registration request; and, when the status tag associated to a particular set of know-how is modified, the know-how registering unit 23 can perform updating by associating the modified status tag to the know-how. For example, when a set of know-how is received in response to a know-how presentation request, the presenting unit 33 of the terminal device 3 presents the received know-how along with the status tag associated to the know-how. Subsequently, if the status tag associated to the know-how is modified by the user, the know-how receiving unit 31 receives a know-how modification request including the modified status tag. Then, the know-how receiving unit 31 sends the received know-how modification request to the information providing device 2. Upon receiving the know-how modification request, the know-how registering unit 23 of the information providing device 2 updates the modified status tag 24b in a corresponding manner to the know-how 24f in the know-how DB 24. Meanwhile, that is applicable not only in the case of modifying the status tag corresponding to the know-how, and the know-how registering unit 23 can also modify the know-how itself.

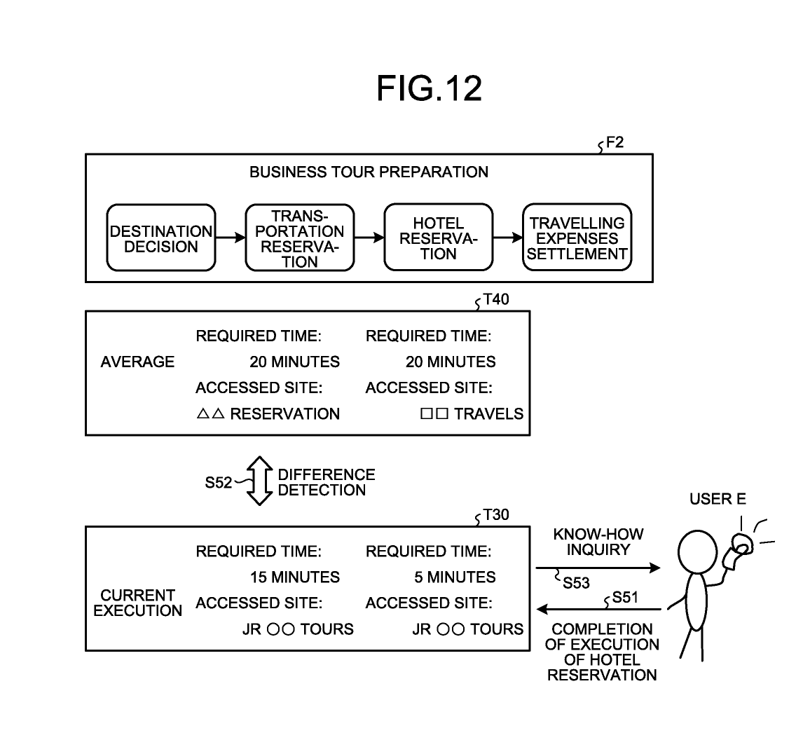

Moreover, in the embodiment described above, it is explained that, in the information providing device 2, when the know-how of the task that is being actually executed by a user is autonomously posted, the know-how is registered in the know-how DB 24. However, that is not the only possible case. Alternatively, in the information providing device 2, when the sensing information during the current execution of the task is different than the sensing information during the past execution of that task, the executant can be prompted to post the know-how during the current execution of the task. Subsequently, when a know-how registration request is received, the know-how registering unit 23 of the information providing device 2 can register the status tag including the sensing information during the current execution along with a comment as the know-how in the know-how DB 24. Explained below with reference to FIG. 12 is a case in which the executant is prompted to perform know-how registration.

FIG. 12 is a diagram illustrating an example of prompting for know-how registration. As illustrated in FIG. 12, in a task flow F2 regarding business tour preparation; “destination decision”, “transportation reservation”, “hotel reservation”, and “traveling expenses settlement” are set as tasks in that order. The information providing device 2 receives a notification of the completion of execution of the task of “hotel reservation” (S51). Then, the information providing device 2 detects the difference between the sensing information T30 during the current execution by a user E and an average T40 of the sensing information during the past execution (S52). Herein, as the sensing information T30 during the current execution, when the “accessed site” is “JR ∘∘∘ tours”, the “required time” is “15 minutes”; and, when the “accessed site” is “JR ∘∘∘ tours”, the “required time” is “5 minutes”. As the average T40 of the sensing information during the past execution, when the “accessed site” is “⋄⋄⋄ reservation”, the “required times” is “20 minutes”; and, when the “accessed site” is “□□□ travels”, the “required time” is “20 minutes”. The information providing device 2 detects that the sensing information T30 during the current execution indicates completion in a shorter period of time than the average T40 of the sensing information during the past execution. Thus, the information providing device 2 inquires the user E about the know-how (S53). Subsequently, when a know-how registration request is received from the terminal device 3 of the user E, the know-how registering unit 23 of the information providing device 2 can register the tag status, which includes the sensing information during the current execution, and a comment as the know-how in the know-how DB 24. As a result, regarding the task “hotel reservation”, the information providing device 2 can keep the superior execution status as compared to the past execution status as the know-how, and thus can provide appropriate know-how for the users who would execute the same task “hotel reservation” in the future.

Moreover, in the embodiment described above, it is explained that, in the information providing device 2, the sets of know-how registered in the know-how DB 24 are extracted and the extracted sets of know-how are presented with the order of priority. However, that is not the only possible case. Alternatively, in the information providing device 2, the know-how registered in the know-how DB 24 can be analyzed. As a result of analyzing the know-how, in the information providing device 2, the sequence of execution of the task flows can be changed and thus efficient task flows can be created.

Furthermore, in the embodiment described above, it is explained that the user status obtaining unit 32 is included in the user interface device (terminal device) 3 in possession of the user. However, that is not the only possible case. Alternatively, the user status obtaining unit 32 can be included in a surrounding device of the terminal device 3.

Moreover, in the embodiment described above, it is explained that the presenting unit 33 of the user interface device (terminal device) 3 sends a know-how presentation request for presenting the know-how related to the tasks, and presents the know-how received in response to the know-how presentation request. However, alternatively, the terminal device 3 can keep the sets of know-how downloaded in advance; generate status tags therein; and register the sets of know-how. In addition, the terminal device 3 can generate status tags therein; extract the sets of know-how with the status tags serving as the keys; and present the sets of know-how. For example, the terminal device 3 can be configured to further include the status tag generating unit 22, the know-how registering unit 23, the know-how extracting unit 25, and the priority determining unit 26 of the information providing device 2.

The scheduling supporting system 9 according to the embodiment described above can be so configured that the information providing device 2 has the functions of the scheduling supporting device 1. Moreover, the information providing device 2 according to the embodiment can be configured to have specialized usage for single users. That is, for example, the information providing device 2 can be configured to have the function of extracting the registered know-how on a user-by-user basis. In this way, from the know-how registered in the past by the same user as the executant, appropriate information can be provided.

Meanwhile, in the embodiment described above, the constituent elements of the devices illustrated in the drawings are merely conceptual, and need not be physically configured as illustrated. That is, the specific configurations of the constituent elements are not limited to the illustrated configurations and the constituent elements, as a whole or in part, can be separated or integrated either functionally or physically based on various types of loads or use condition. For example, the know-how extracting unit 25 and the priority determining unit 26 can be integrated into a single constituent element. Moreover, the status tag generating unit 22 can be separated into a status tag generating unit for know-how registration and a status tag generating unit for know-how presentation. Furthermore, the know-how DB 24 can be connected via a network as an external device of the information providing device 2.

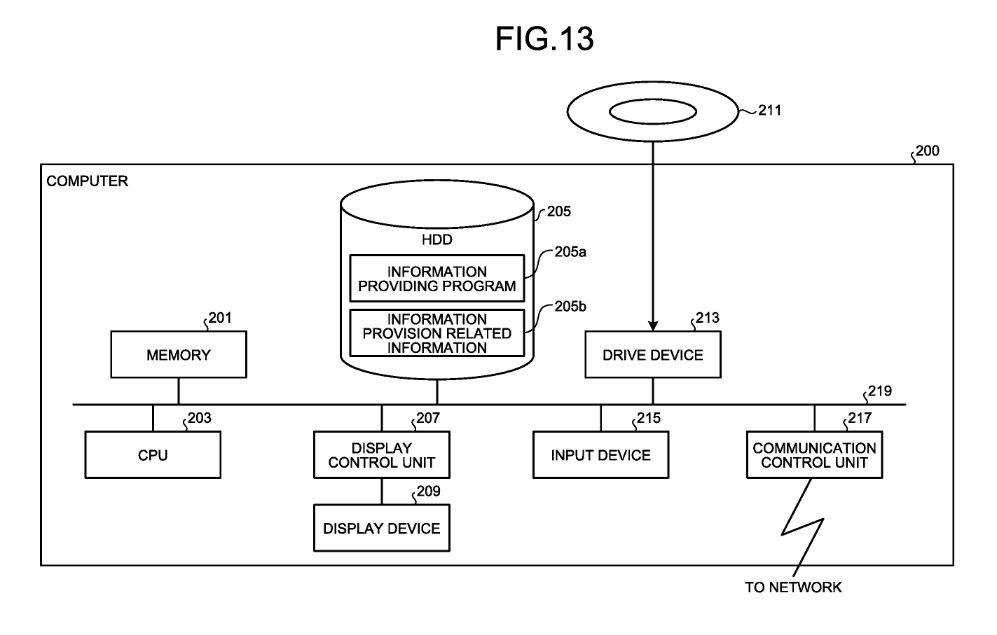

The various operations explained in the embodiment described above can be implemented by making a computer such as a personal computer or a workstation execute a computer program written in advance. The following explanation is given about an exemplary computer that executes an information providing program for implementing identical functions to the information providing device 2 illustrated in FIG. 1. FIG. 13 is a diagram illustrating an exemplary computer that executes the information providing program.

As illustrated in FIG. 13, a computer 200 includes a central processing unit (CPU) 203; an input device 215 that receives input of data from the user; and a display control unit 207 that controls a display device 209. Moreover, the computer 200 includes a drive device 213 that reads computer programs from a memory medium; and a communication control unit 217 that performs communication of data with other computers via a network. Furthermore, the computer 200 includes a memory 201 for temporarily storing a variety of information, and includes a hard disk drive (HDD) 205. Herein, the memory 201, the CPU 203, the HDD 205, the display control unit 207, the drive device 213, the input device 215, and the communication control unit 217 are connected to each other by a bus 219.

The drive device 213 is a device to be used for, for example, a removable disk 211. The HDD 205 is used to store an information providing program 205a and information provision related information 205b.

The CPU 203 reads the information providing program 205a, loads it in the memory 201, and executes it as a process. That process corresponds to the functional units of the information providing device 2. The information provision related information 205b corresponds to the know-how DB 24. Then, a variety of information such as the information providing program 205a is stored in, for example, the removable disk 211.

Meanwhile, the information providing program 205a need not necessarily be stored in the HDD 205 from the beginning. For example, the information providing program 205a can be stored in a “portable physical medium” such as a flexible disk (FD), a compact disk read only memory (CD-ROM), a digital versatile disk (DVD), a magneto-optical disk, or an IC card, inserted into the computer 200. Then, the computer 200 can read the information providing program 205a from the portable physical medium and execute it.

According to an aspect, it becomes possible to provide the appropriate know-how for the user.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information providing method comprising:
generating, at time of registering know-how with respect to a task defined in task information, a first-type status tag based on a user status including task information of a first task being executed by a first user, by a processor;
storing the first-type status tag in a corresponding manner to the know-how in a memory, by the processor;
generating a second-type status tag based on a user status including task information of a second task being executed by a second user, by the processor;
extracting, from a plurality of sets of know-how stored in the memory, know-how associated to the second-type status tag, by the processor; and
providing the extracted know-how to the second user, by the processor.

2. The information providing method according to claim 1, wherein
the generating of the first-type status tag includes generating the first-type status tag based on task information of the first task being executed by the first user and based on information decided in preceding task, by the processor and
the generating of the second-type status tag includes generating the second-type status tag based on task information of the second task being executed by the second user and based on information decided in preceding task, by the processor.

3. The information providing method according to claim 1, wherein
when a plurality of sets of know-how are extracted, according to degrees of coincidence of status tags associated to the extracted sets of know-how and the second-type status tag, ordering for provision is done with respect to the extracted sets of know-how, by the processor, and
the providing includes providing the extracted sets of know-how according to the ordering to the second user, by the processor.

4. The information providing method according to claim 1, wherein the user status includes task information of the task, information about application used at time of execution of a task by a user, and information of a predetermined sensor.

5. A non-transitory computer-readable recording medium storing therein an information providing program that causes a computer to execute a process comprising:
generating, at time of registering know-how with respect to a task defined in task information, a first-type status tag based on a user status including task information of a first task being executed by a first user;
storing the first-type status tag in a corresponding manner to the know-how in a memory;
generating a second-type status tag based on a user status including task information of a second task being executed by a second user;
extracting, from a plurality of sets of know-how stored in the memory, know-how associated to the second-type status tag; and
providing the extracted know-how to the second user.

6. An information providing device comprising:
a processor configured to:
generate, at time of registering know-how with respect to a task defined in task information, a first-type status tag based on a user status including task information of a first task being executed by a first user;
store the first-type status tag in a corresponding manner to the know-how in a memory;
generate a second-type status tag based on a user status including task information of a second task being executed by a second user;
extract, from a plurality of sets of know-how stored in the memory, know-how associated to the second-type status tag; and
provide the extracted know-how to the second user.
